(19) United States
(12) Patent Application Publication
(10) Pub. No.: US 2005/0262621 A1
(43) Pub. Date: Dec. 1, 2005

(54) Urinal for a hunter's tree stand

(76) Inventor: Delano Archie Dalton, Lake Lure, NC (US)

Correspondence Address: THE INVENTORS NETWORK, INC., 332 ACADEMY STREET, CARNEGIE, PA, 15106, US

(21) Appl. No.: 10/857,570

(22) Filed: Jun. 1, 2004

(51) Int. Cl. E06C 7/16; A47K 11/00

(52) U.S. Cl. 4/144.1

(57) ABSTRACT

A urinal device for a hunter's tree stand includes a urinal bowl having a mounting bracket for securing the urinal bowl to the tree trunk, a lid pivotally mounted to the urinal bowl for allowing access to the urinal bowl, a drain connector extending from the bottom of the urinal bowl and in registration therewith, and a plurality of conduit sections of variable length interconnected to the drain connector and extending downwardly from the urinal bowl through the tree stand adjacent the tree trunk and terminating with one conduit section inserted into the ground thereby providing a continuous drainage system for discharging the urine into the ground so that the urine odor is contained within the drainage system and thus allowing the hunter to remain in the tree stand to urinate.

### FIELD OF THE INVENTION

The present invention pertains to urinal devices, and more particularly pertains to a urinal device that can be incorporated with a hunter's tree stand to provide for urination while remaining in the tree stand.

### BACKGROUND OF THE INVENTION

Hunting, and especially the hunting of large game animals, requires a number of conditions to be successful. Certainly expertise with firearms and knowledge of the terrain and habits of the animal being hunted are things that all hunters need to be successful. In addition, knowledge of the movements and activities of the animal being hunted is requisite so that the hunter can position himself in a secluded, undetected location that affords the optimum vantage for observing and then shooting the animal. Hunters will often use tree stands to obtain a better vantage of the terrain and the animal. While tree stands provide a hunter with a wider view hunting terrain, the hunter may still have to sit quiet and motionless in the tree stand for hours until the animal comes within shooting range. Thus, the one obvious disadvantage from hunting in a tree stand is that it complicates the relief of bodily functions, such as urination. A simple solution is to take a jug or container up into the tree stand to urinate in; however, tree stands are not large, and the jug or container is an extra item that could get in the hunter's way and could be inadvertently knocked out of the tree stand thereby spilling the contents on the ground and spooking any animals that may be in the area. The only other solution is for the hunter to climb down the tree stand and locate some unobtrusive place to urinate. But this defeats the purpose of tree stand hunting as the noise and movement the hunter I makes while climbing down and up the tree stand, in addition to the urine odor that now pervades the area surrounding the tree stand, will certainly spook any animal from coming anywhere near the tree stand.

Thus, the prior art discloses a number of devices for collecting and discharging urine usable in both hunting and non-hunting applications. For example, the Kliemann patent (U.S. Pat. No. 3,832,738) discloses a funnel-shaped urine collector that attaches to the upper end of a urine container closed off by a cap tethered thereto.

The Darling patent (U.S. Pat. No. 3,851,650) discloses a closed drainage system having a catheter for insertion into the body appendage or cavity and a pair of lumens for draining liquid from the catheter and alleviating any negative pressure buildup in the system.

The Miller patent (U.S. Pat. No. 3,931,650) discloses a disposal device for wheelchairs wherein a drain tube extends from the wheelchair seat and can be emptied by the seated individual through a valve that is lever operated or solenoid actuated.

The Knight patent (U.S. Pat. No. 4,309,779) discloses a personal urinal device that includes a semi-rigid housing having both a spout and an opening for allowing both males and females to urinate therein.

The Siegrist patent (U.S. Pat. No. 6,370,701 B1) discloses a self-contained urine collection device that includes a cap for closing off the spout and a strap that can extend about a tree trunk for securing the device to the trunk.

The Palumbo et al. patent (U.S. Pat. No. 6,491,673 B1) discloses a disposable urine collector that includes an opening circumscribed by adhesive-faced flaps that provide for the releasable attachment of the collector to the individual.

Nonetheless, despite the ingenuity of the above devices, there remains the need for a device that allows the hunting to urinate without ever leaving the tree stand, and provides for the continuous evacuation of urine thereby minimizing or eliminating odor, noise, and movement by the hunter.

### SUMMARY OF THE INVENTION

The present invention comprehends a urinal device that can be incorporated with a hunter's tree stand to allow the hunter to urinate without ever leaving the tree stand while at the same time discharging the urine into the ground so that odor, noise and movement is minimized or eliminated altogether.

The urinal device of the present invention includes a urinal basin or bowl having an upper end with a mounting bracket extending from the upper end so that the basin can be secured to or about the tree trunk. The urinal basin also includes a pivotal lid for allowing access to the basin for urination therein and for closing the basin so that the urine odor doesn't permeate the surrounding area. Attached to the bottom of the basin is a drain connector in registration with the basin for allowing drainage of the urine, and a plurality of conduit sections can be joined together for extension downward from the drain connector and insertion into the ground so that the urine is completely enclosed as it is conveyed from the urine basin, downward through the conduit sections and thence for discharge into the ground.

It is an objective of the present invention to provide a urinal device for a hunter's tree stand that obviates the irksome inconvenience of the hunter having to climb down from the tree stand to relieve himself.

It is another objective of the present invention to provide a urinal device for a hunter's tree stand that reduces or minimizes the hunter's movements by allowing the hunter to urinate without leaving the tree stand.

It is still yet another objective of the present invention to provide a urinal device for a hunter's tree stand that eliminates the need for the hunter to carry a container or jug for urination up into the tree stand.

It is still yet a further objective of the present invention to provide a urinal device for a hunter's tree stand that allows the hunter to urinate in an easy and sanitary manner while remaining in the tree stand.

Still yet another objective of the present invention is to provide a urinal device for a hunter's tree stand that eliminates the odor arising from outdoor urination thereby allowing the hunter to remain undetected by the game animals.

Still yet a further objective of the present invention is to provide a urinal device for a hunter's tree stand that eliminates the noise and movement that would otherwise result from the hunter climbing down and up the tree stand a number of times to urinate.

A still yet further objective of the present invention is to provide a urinal device for a hunter's tree stand that facilitates the hunting of game animals by allowing the hunter to remain relatively still and quiet in the tree stand even during periods of urination.

These and other objects, features and advantages will become apparent to one skilled in the art upon a perusal of the following detailed description read in conjunction with the accompanying drawing figures.

### BRIEF DESCRIPTION OF THE DRAWINGS

FIG. 1 is a perspective view of the urinal device for a hunter's tree stand illustrating the mounting of the urinal device to the tree stand and secured to the tree trunk;

FIG. 2 is a perspective view of the urinal device for a hunter's tree stand illustrating the securement of several conduit sections to the basin of the urinal device;

FIG. 3 is a side elevational view of the urinal device for a hunter's tree stand illustrating the arrangement of the conduit sections in their extension from the tree stand to the ground;

FIG. 4 is a sectioned elevational view of the urinal device for a hunter's tree stand taken along lines 4-4 of FIG. 1 illustrating the urinal device in the closed, non-use position;

FIG. 5 is a sectioned elevational view of the urinal device for a hunter's tree stand taken along lines 4-4 of FIG. 1 illustrating the urinal device in the open, use position; and

FIG. 6 is a side elevational view of the urinal device of the present invention illustrating a single flexible, unitary conduit section extending from the urinal device downwardly adjacent the tree trunk for anchoring and termination in the ground.

### DETAILED DESCRIPTION OF THE PREFERRED EMBODIMENT

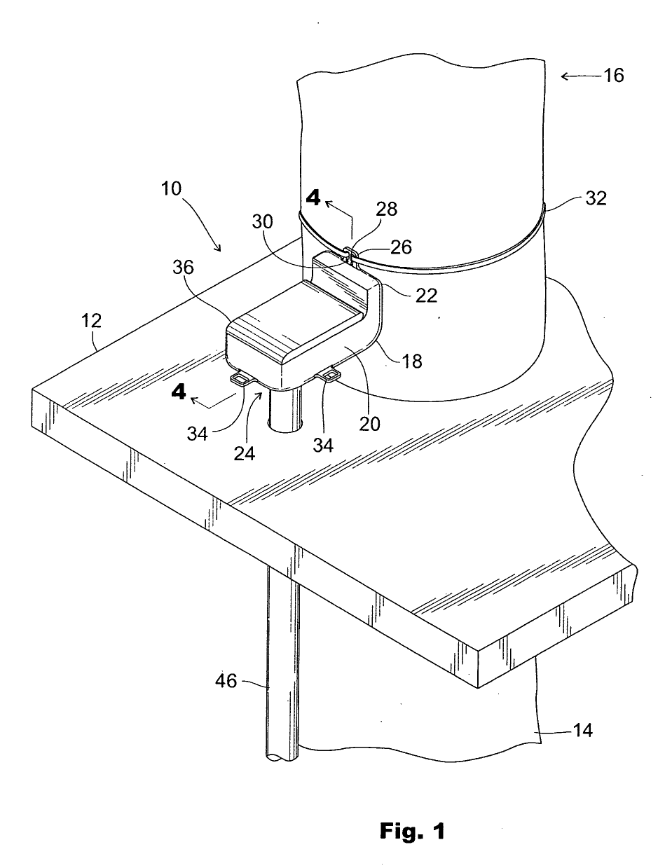

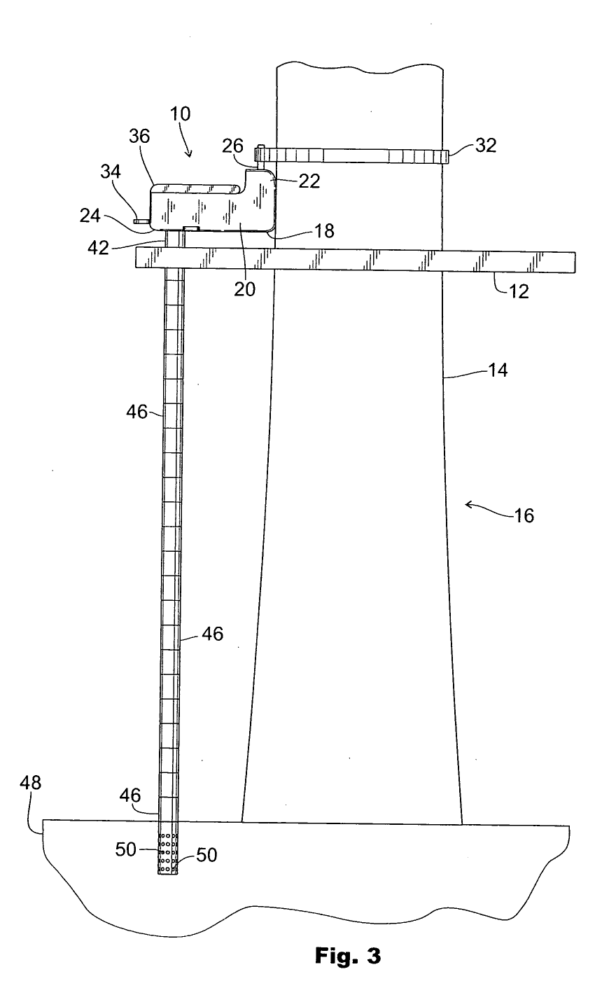

Illustrated in FIGS. 1-6 is a urinal device 10 that is supported on a tree stand 12 that is itself secured to the trunk 14 of a tree 16 for allowing the hunter to use the urinal device 10 for urination while remaining on the tree stand 12 relatively still and quiet. Tree stands come in many designs and configurations, and the tree stand 12 shown in FIGS. 1 and 3 is for illustrative purposes. The urinal device 10 of the present invention obviates the problem and inconvenience of the hunter having to climb down the tree stand 12 to urinate, and then climb back up all the while moving, making noise, rustling branches and leaving a urine odor easily detectable by the keen sense of smell of game animals and thus spooking the game animals.

Thus, the urinal device 10 shown in FIGS. 1-6 includes a urinal bowl or basin 18 for the hunter to urinate in. The urinal bowl 18 is of lightweight plastic construction (generally PVC plastic), and is 1-shaped in configuration. The urinal bowl 18 includes a continuous sidewall 20, an upper end 22 that generally abuts the tree trunk 14, and an opposite lower or bottom discharge end 24. Projecting from the upper end 22 is a primary mounting bracket 26, and the primary mounting bracket 26 includes a pair of strap slots 28 and a pair of mounting holes 30 that provides several methods of mounting the urinal device 18 to the tree trunk 14. Fasteners, such as screws or bolts, can be inserted through the mounting holes 30 and into the tree trunk 14 for securing the urinal device 10 to the tree trunk 14; in the alternative, a flexible strap 32 can be inserted 5 through the strap slots 28 for encircling the tree trunk 14 and thereby securing the urinal bowl 18 thereto. The strap 32 can be tightened or loosened as required to obtain the most reliable securement.

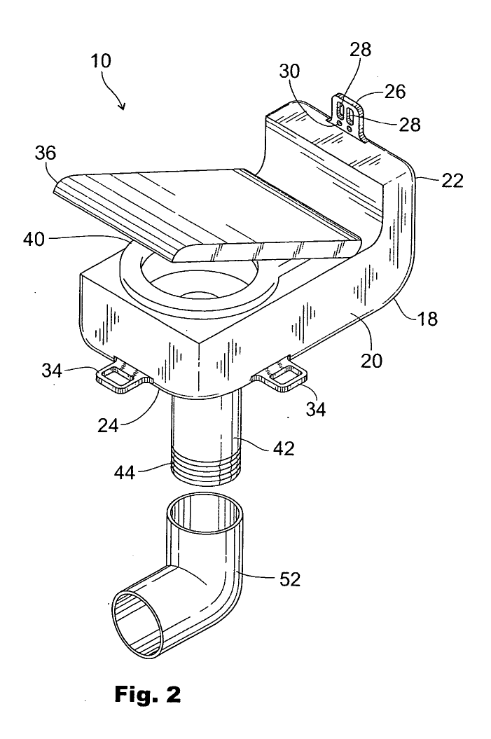

As shown in FIGS. 1 and 2, the urinal device 10 also includes secondary mounting brackets 34 that project laterally from the sidewall 20 and are located on the front and opposed side portions of the sidewall 20. The secondary mounting brackets 34 allow the urinal bowl 18 to be secured to the tree stand 12 at alternate mount points thereby enhancing the securement of the urinal bowl 18 to the tree stand 12.

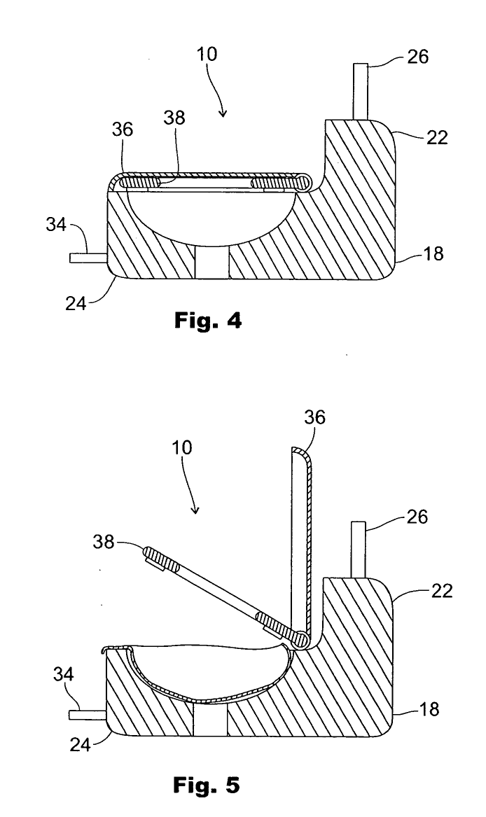

As illustrated in FIGS. 1-5, a lid 36 is pivotally mounted to urinal bowl 18, and the lid 36 pivots between a closed, non-use position and an open, use position. A seat member 38 can also be included as shown in FIGS. 4 and 5, and as shown in FIG. 5, the seat member 38 pivots independent of the lid 36. To provide an airtight closure of the urinal bowl 18 when the lid 36 is closed, a seal or gasket, such as the rubber seal 40 shown in FIG. 2, can be placed on the flat top wall of the urinal bowl 18.

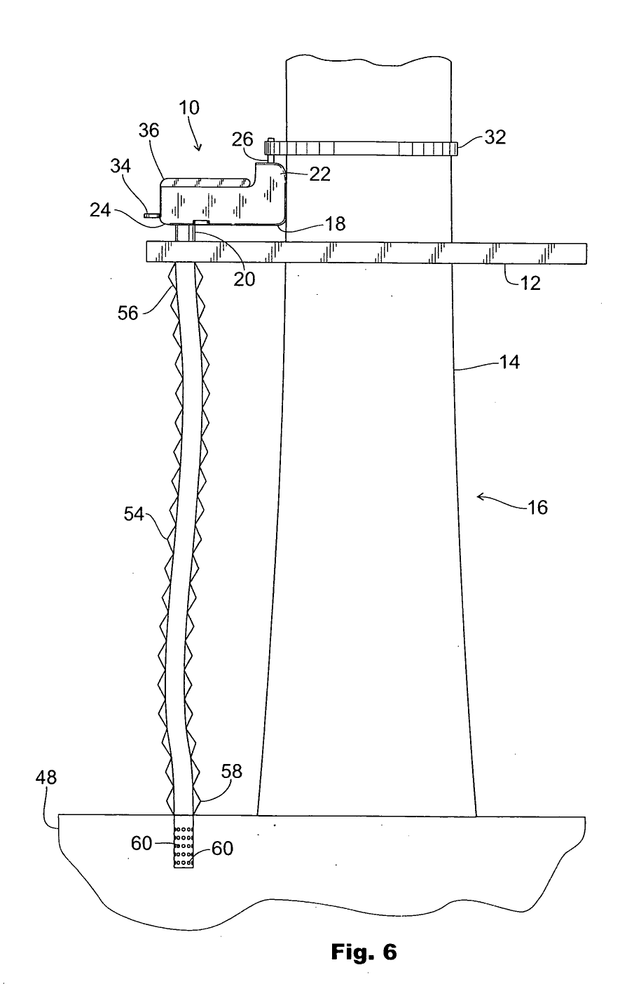

Illustrated in FIGS. 1, 3 and 6 is a drain connector 42 that is connected to the underside of the bottom discharge end 24 of the urinal bowl 18. The drain connector 42 is in flow registration with the urinal bowl 18 so that urine is directed from the urinal bowl 18 down through the drain connector 42. The drain connector 42 has a threaded lower end 44, and secured to the threaded lower end 44 is one of a plurality of straight conduit sections 46. The conduit sections 46 can come in various lengths such as five foot lengths and one foot lengths so that a tree stand 12 mounted 12 feet above the ground would include two five foot conduit sections 46 and one conduit section 46 one foot long. All the conduit sections 46, irrespective of length, have one threaded end so that all the conduit sections 46 can be adjoined end-to-end to form a linear arrangement for directing urine from the urinal bowl 18 to the ground 48. In addition, the drain connector 42 and the conduit sections 46 can be ½ inch or one-inch plastic—PVC—pipe. As shown in FIGS. 3 and 6, the bottommost conduit section 46 is driven, placed or inserted into the ground 48 and includes a plurality of drain holes 50 adjacent its lower end. Urine is thus discharged from this ground-inserted conduit section 46 for discharge and permeation into the ground 48.

As shown in FIG. 2, an elbow conduit section 52 can also be used when it is necessary to space the conduit sections 46 from the tree trunk 14. The elbow conduit section 52 has internal threads for connecting to the lower threaded end 44 of the drain connector 42; and, in fact, two elbow conduit sections 52 will be needed to interconnect the straight conduit sections 46 to the drain connector 42 for spacing the straight conduit sections 46 from the tree trunk 14 and off center of the urinal bowl 18.

FIG. 6 illustrates an alternative to the interconnected conduit sections 46 shown in FIG. 3. Thus, in place of the interconnected conduit sections 46, FIG. 6 illustrates a single flexible extensible conduit member 54 having an upper end 56 connected to the drain connector 42 and a lower end 58 for insertion into the ground 48 with the lower end 58 having drain holes 60 for allowing the urine to drain and seep into the ground 48. The unitary conduit member 54 of FIG. 6 can be of an extensible and retractable structure similar to the flexible conduit that dryers use to vent hot air to the external environment.

Thus, when the urinal device 10 shown in FIGS. 1-6 is disposed in its operative Is position of being mounted on the tree stand 12 and secured to the tree trunk 14, a continuous closed urine drainage system is created whereupon the urine is contained within the urinal device 10 as the urine is conveyed from the urinal bowl 18, through the drain connector 42 and thence downward within the conduit sections or conduit member 46 or 54 for discharge into the ground 48. At no point is the odor of urine allowed or able to escape to the external environment warning and spooking game animals within the vicinity of the hunter. To further assist the hunter all the elements of the urinal device 10 can be coated or painted in a suitable camouflaged manner to conceal as much as possible the urinal device 10 from visual detection by any game animals.

While particular embodiments of the invention have been shown and described, it would be obvious to one skilled in the art that numerous modifications, alterations, and variations can be made without departing from the spirit and scope of the invention, and the appended claims are intended to cover all such modifications, alterations, and variations that are within the scope of this invention.

1. A urinal device supported on a hunter's tree stand that is mounted to the trunk of the tree for allowing the hunter to urinate without leaving the tree stand and for directing the urine into the ground, comprising:
a urinal basin having an upper end and an opposite bottom discharge end;
at least one mounting bracket located at the upper end for securing the urinal basin to the tree trunk;
a lid pivotally secured adjacent the upper end of the urinal basin for pivoting between a closed, non-use position and an open, use position so that the hunter can urinate in the urinal basin;
a drain connector attached to the bottom discharge end of the urinal basin and in flow registration with the urinal basin for directing urine downwardly from the urinal basin;
a plurality of conduit sections capable of being joined end to end commencing at the drain connector for extension downward adjacent the tree trunk and terminating with at least one conduit section inserted into the ground for discharging the urine into the ground; and
the urinal basin, the drain connector and the conduit sections forming a completely closed urine drainage system whereupon the urine odor is contained within the drainage system and does not permeate the area surrounding the hunter's tree stand.

2. The urinal device of claim 1 further comprising a flexible strap that is attachable to the mounting bracket for encircling the tree trunk so that the urinal device can be secured to the tree trunk.

3. The urinal device of claim 2 further comprising a plurality of secondary mounting brackets disposed about the urinal basin and projecting outwardly therefrom for providing alternative locations for securing the urinal device to the hunter's tree stand.

4. The urinal device of claim 3 further comprising at least one elbow conduit section that is attachable to the drain connector and the conduit sections for spacing the conduit sections off center from the urinal basin.

5. The urinal device of claim 4 wherein a camouflage design and coloring can be applied to the urinal device to conceal the urinal device from visual detection by game animals.

6. A urinal device supported on a hunter's tree stand that is mounted to the trunk of a tree for allowing the hunter to urinate while remaining in the tree stand and the urinal device discharging the urine directly into the ground, comprising:
a urinal bowl having an upper end and an opposite bottom discharge end;
a primary mounting bracket located at the upper end for securing the urinal bowl to the trunk of the tree;
a lid pivotally secured to the urinal bowl for pivoting between a closed, non-use position and an open, use position so that the hunter can urinate in the urinal bowl;
a drain connector extending downwardly from the bottom discharge end of the urinal bowl through the tree stand and in flow registration with the urinal bowl for directing urine downwardly from the urinal bowl;
a plurality of conduit sections capable of being joined end to end for linear extension downward from the urinal bowl and adjacent the tree trunk and terminating with at least one conduit section inserted into the ground so that the conduit sections can direct the urine downwardly from the urinal bowl for dispersal in the ground;
a flexible strap securable to the primary mounting bracket for encircling the tree trunk in order to secure the urinal bowl to the tree trunk; and
the urinal bowl, the drain connector and the conduit sections forming a completely enclosed urine drainage system whereupon the urine is contained within the drainage system for discharge into the ground and urine odor is prevented for permeating the area surrounding the hunter's tree stand.

7. The urinal device of claim 6 further comprising an elbow conduit section attachable to the drain connector for joining the drain connector to the conduit sections and spacing the conduit sections off center of the urinal bowl.

8. The urinal device of claim 7 wherein a camouflage paint can be used to conceal the urinal device from visual detection by game animals.

9. The urinal device of claim 8 further comprising a plurality of secondary mounting brackets spaced about the urinal bowl and projecting laterally therefrom for providing secondary positions for securing the urinal bowl to the tree stand.

10. A urinal device supported on a hunter's tree stand that is mounted to the trunk of a tree for allowing the hunter to urinate without leaving the tree stand and for directing the urine down from the tree stand for discharge into the ground, comprising:
a urinal bowl having an upper end and an opposite lower discharge end;
at least one primary mounting bracket located at the upper end of the urinal bowl for securing the urinal bowl to the tree trunk;
a lid pivotally secured to the urinal bowl and capable of pivoting between a closed, non-use position and an open, use position so that the hunter can urinate into the urinal bowl;
a drain connector attached to the lower discharge end of the urinal bowl and in flow registration therewith for directing urine downwardly from the urinal bowl;
a flexible and extensible conduit member having an upper end for attachment to the drain connector and a lower end for insertion into the ground so that urine can be conveyed through the conduit member for discharge into the ground; and
the urinal bowl, the drain connector and the conduit member forming a completely closed urine drainage system whereby the urine odor is contained within the drainage system and is prevented from escaping to the external environment.

11. The urinal device of claim 10 further comprising a flexible strap that is attachable to the primary mounting bracket for encircling the tree trunk so that the urinal bowl is secured to the tree trunk.

12. The urinal device of claim 11 further comprising a plurality of secondary mounting brackets disposed about the urinal bowl and projecting laterally therefrom for providing locations for securing the urinal bowl to the tree stand.

13. The urinal device of claim 12 further comprising at least one elbow conduit section that is attachable to the drain connector and the upper end of the flexible and extensible conduit member for spacing the conduit member off center from the urinal bowl and further away from the tree trunk.

14. The urinal device of claim 13 further comprising the application of a camouflage design to the urinal device to conceal the urinal device from visual detection by game animals.
